(19) United States
(12) Patent Application Publication
(10) Pub. No.: US 2007/0086456 A1
(43) Pub. Date: Apr. 19, 2007

(54) Integrated layer frame processing device including variable protocol header

(75) Inventors: Dae ub Kim, Daejeon-city (KR); Bheom Soon Joo, Daejeon-city (KR); Jung Sik Kim, Daejeon-city (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/634,928

(22) Filed: Dec. 7, 2006

(30) Foreign Application Priority Data
Aug. 12, 2005 (KR) 10-2005-0120103
Jul. 7, 2006 (KR) 10-2006-0064013

(51) Int. Cl. H04L 12/56

(52) U.S. Cl. 370/389

(57) ABSTRACT

An integrated layer frame processing device for supporting Internet Protocol version 6 (Ipv6), in which the number of bytes to be processed is more than in Ipv4, and securing a bandwidth of at least several gigabits using an existing network processor is provided. The integrated layer frame processing device includes a variable header into which information is compressed and inserted and a hash key is generated in a data field that is recognized by a network processor so as to support a packet processing protocol for a system including a frame switch and a router. The integrated layer frame processing device is disposed between a physical layer and layer 2 processor and the network processor. Since the integrated layer frame processing device includes the variable header, a case where the number of bytes that are to be processed by the network processor is increased can be managed appropriately. Accordingly, the network processor can support Ipv6 and can map and manage layer 4 and layer 2 information as well as layer 3 information, i.e., Ipv4 in hardware.

### CROSS-REFERENCE TO RELATED PATENT APPLICATIONS

This application claims the benefits of Korean Patent Application No. 10-2005-0120103, filed on Dec. 8, 2005, and Korean Patent Application No. 10-2006-0064013, filed on Jul. 7, 2006, in the Korean Intellectual Property Office, the disclosures of which are incorporated herein in their entirety by reference.

### BACKGROUND OF THE INVENTION

1. Field of the Invention

The present invention relates to a system including a frame switch and a router, and more particularly, an integrated layer frame processing device for supporting a packet processing protocol needed by a system user.

2. Description of the Related Art

Most conventional frame switches and routers, which can perform several gigabit packet processing in a network, operate only in Internet Protocol version 4 (IPv4), which is a conventional Internet addressing system, and do not support Quality of Service (QoS), which provides a band for a service needed by a user or by equipment. Even if conventional frame switches and routers support IPv6 addressing, it is only Ipv6 that they support, depending on software and memory, and therefore, it is difficult to secure even a 100-megabit bandwidth.

Accordingly, a packet processor, i.e., a network processor, needs to process packets or frames in hardware in order to support Ipv6 and secure at least several gigabit packet processing. However, network processors dependent on Ipv4 are limited in terms of recognizing a data field using a standard frame and thus cannot support Ipv6. Even if the network processors can support Ipv6, they cannot perform packet processing at at least several gigabits per second since they depend on software and memory when processing packets or frames.

FIG. 1 illustrates a typical line card data processing unit in a conventional frame switch and router system. Referring to FIG. 1, a physical layer and media access control (MAC) layer processor 10 transmits a data frame via a system packet interface (SPI) 30 to a network processor 20 as a “layer 2” frame like a Point-to-Point Protocol (PPP) using Ethernet or a high level data link controller (HDLC). The network processor 20 analyzes all standard areas in the frame according to its performance. At this time, the physical layer and MAC layer processor 10 and the network processor 20 transmit and receive protocol information, which is to be processed, to and from a control processor (not shown) via a control processor interface 40. The physical layer and MAC layer processor 10 is connected with external Internet through an optical or a copper cable 15 and the network processor 20 is connected with a backplane (in network equipment) through a switch fabric interface 25.

As described above, the conventional network processor 20 dependent on Ipv4 is limited in terms of recognizing a data field using a standard frame or depends on software and memory when processing an extended information area. As a result, the network processor 20 cannot perform packet processing at over several gigabits per second.

### SUMMARY OF THE INVENTION

The present invention provides an integrated layer frame processing device for supporting Internet Protocol version 6 (Ipv6), in which the number of bytes to be processed is more than in Ipv4, and for securing a bandwidth of at least several gigabits using an existing network processor.

According to an aspect of the present invention, there is provided an integrated layer frame processing device in a system including a frame switch and a router. The integrated layer frame processing device includes a variable header into which information is compressed and inserted and in which a hash key is generated in a data field that is recognized by a network processor so as to support a packet processing protocol for the system. The integrated layer frame processing device is disposed between a physical layer and layer 2 processor and the network processor.

The layer 2 may be a media access control (MAC) layer used in Ethernet. The physical layer and layer 2 processor and the integrated layer frame processing device may be connected through a first system packet interface. The integrated layer frame processing device and the network processor may be connected through a second system packet interface. The physical layer and layer 2 processor, the integrated layer frame processing device, and the network processor may be connected to a control processor interface that defines setting information of each layer in open system interconnection for a user, a type of frame to be processed, and a size of each layer information field.

The integrated layer frame processing device may further include an entrance interface converter storing information about a physical layer defined in the first 10 system packet interface in a physical layer information field in the variable header of the data field, transmitting a frame through a path having a maximum bandwidth regardless of the number of channels of the first system packet interface, and writing channel information into the variable header; a layer 2 frame setting block receiving the frame through the path having the maximum bandwidth, extracting layer 2 information from a frame predefined in a layer 2 protocol, and storing the layer 2 information in a layer 2 information field in the data field; an integrated layer frame processing block comprising the variable header which integrates and stores different layer information predefined by the control processor interface and performing processes according to a layer; a frame multiplexer multiplexing frames differently processed by the integrated layer frame processing block into a single path and varying a bandwidth of the path through the control processor interface; an exit interface converter receiving header information from a header information field in the data field and the channel information from the physical layer information field, removing all content of the variable header from the data field when the header information is 0, restoring an initial frame input to the entrance interface converter, outputting the initial frame to the second system packet interface, and outputting the content of the variable header to the second system packet interface when the header information is not 0; and an integrate layer frame restoration block removing the content of the variable header from a frame that is processed by the network processor and output to a corresponding physical layer port, allowing the layer 2 frame setting block to set in the frame its layer 2 address defined by the control processor interface, and allowing the physical layer and layer 2 processor to process a normal standard protocol frame.

The data field may include the variable header and a payload field. The payload field may reflect an entire frame structure defined in a standard protocol or a frame excluding information extracted to the variable header. The variable header may vary so as to support a packet processing protocol for the system. The variable header may include a hash key field, the header information field, the physical layer information field, the layer 2 information field, a layer 3 information field, and a layer 4 information field.

When a direction in which a frame is output is reverse, the exit interface converter and the entrance interface converter may perform their functions in reverse order. When the header information is not 0, the frame may be divided based on the number of channels in the physical layer defined in the physical layer information according to performance of the network processor and then output to the second system packet interface.

The integrated layer frame processing block may include an information processor receiving information and a size needed to construct a frame in the data field through the control processor interface, extracting information about each layer, and inserting the information into a corresponding layer information field in the variable header; and a hash key generation and output section generating a hash key and writing the hash key into a hash key field in the variable header.

The information processor may include a layer information processing and filtering section for each layer. The integrated layer frame processing block may further include a header information processor receiving outputs from the information processor and the hash key generation and output section and inserting corresponding layer information into the header information field in the variable header.

A bandwidth of a frame input to the integrated layer frame processing block may be the same as a sum of bandwidths of all frames output from the header information processor. The variable header may have a minimum size of 0 and a maximum size corresponding to a sum of bits in every field in the variable header, which is less than or equal to a filtering capacity of the network processor.

Accordingly, the integrated layer frame processing device includes a variable header, in which necessary information is compressed and inserted and a hash key is generated, is included in a data field that can be recognized by a network processor, thereby supporting Ipv6, in which the number of fields, i.e., the number of bytes to be processed in a packet, is increased. In addition, since L4 and L2 information as well as L3 information, i.e., IPv4, can be mapped and managed in hardware, a bandwidth of more than several gigabits can be guaranteed.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a typical line card data processing unit in a conventional frame switch and router system;

FIG. 2 illustrates a line card data processing unit using an integrated layer frame processing device including a variable protocol header according to an embodiment of the present invention in a frame switch and router system;

FIG. 3 is a detailed diagram illustrating the integrated layer frame processing device including a variable protocol header according to an embodiment of the present invention;

FIG. 4 is a detailed diagram illustrating an integrated layer frame processing block included in the integrated layer frame processing device according to the embodiment illustrated in FIG. 3; and

FIG. 5 illustrates the structure of an internal frame used in an embodiment of the present invention.

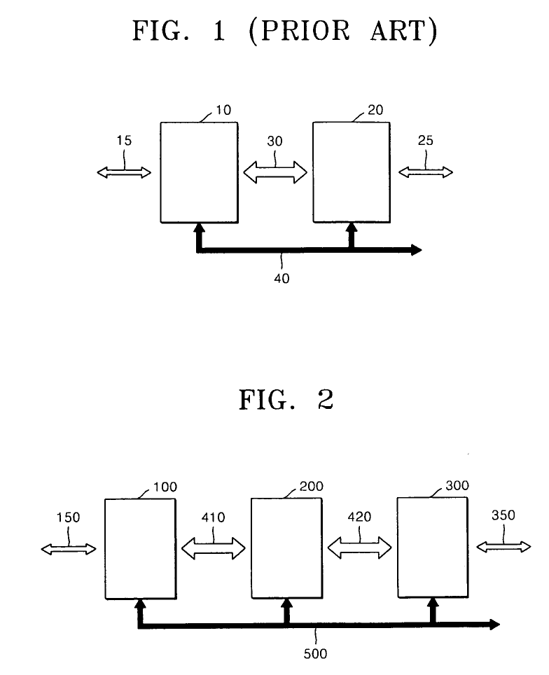

### DETAILED DESCRIPTION OF THE INVENTION

Hereinafter, preferred embodiments of the present invention will be described in detail with reference to the attached drawings. In the drawings, descriptions of elements not related with the present invention will be omitted for the clarity and like reference numerals denote like elements. Terminology should not be construed as limiting the scope of the present invention as defined by the claims; rather, the terminology is provided to fully explain the concept of the invention.

FIG. 2 illustrates a line card data processing unit using an integrated layer frame processing device including a variable protocol header according to an embodiment of the present invention in a frame switch and router system.

Unlike a conventional line card data processing unit, the line card data processing unit according to the current embodiment includes an integrated layer frame processing device 200 between a physical layer and media access control (MAC) layer processor 100 and a network processor 300. The integrated layer frame processing device 200 includes a variable protocol header for compensating for a performance limit of the network processor 300.

The integrated layer frame processing device 200 compresses and inserts desired information into a data field that the network processor 300 can recognize and generates a hash key using the variable protocol header so that Quality of Service (QoS) required by a system user and all layer protocols can be provided. In other words, the integrated layer frame processing device 200 can manage a case where the number of bytes to be processed is increased in a standard frame structure, using the existing network processor 300. Accordingly, the network processor 300 can support Internet Protocol version 6 (IPv6), and layer 4 (L4) information, layer 2 (L2) information, and physical layer information as well as IPv4 corresponding to a layer 3 (L3) are mapped in a data field that the network processor 300 can recognize. As a result, the network processor 300 can process all layer information in hardware. Therefore, the line card data processing unit including the integrated layer frame processing device 200 can ensure a bandwidth of more than several gigabits and can perform QoS and processes required for other services. The physical layer and MAC layer processor 100 and the integrated layer frame processing device 200 are connected to each other via a first system packet interface (SPI) 410. The integrated layerframe processing device 200 and the network processor 300 are connected to each other via a second SPI 420. The first and second SPIs 410 and 420 may be implemented using conventional SPIs. As with conventional technology, protocol information which is to be processed is transmitted to and received from a control processor (not shown) via a control processor interface 500, which is also connected to the integrated layer frame processing device 200. The physical layer and MAC layer processor 100 is connected with external Internet through an optical or a copper cable 150 and the network processor 300 is connected with a backplane (in network equipment) through a switch fabric interface 350.

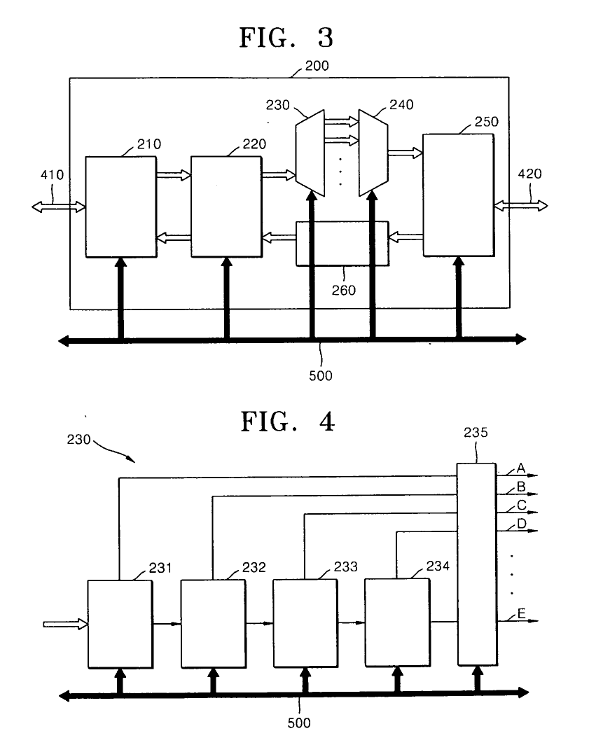

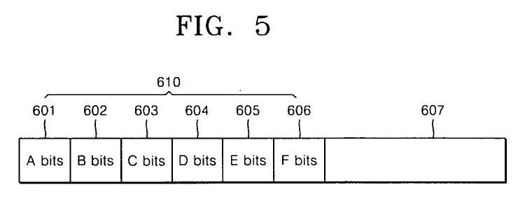

FIG. 3 is a detailed diagram illustrating the integrated layer frame processing device 200 including a variable protocol header according to an embodiment of the present invention. The integrated layer frame processing device 200 will be described with reference to FIGS. 3 and 5 below.

Referring to FIG. 3, the integrated layer frame processing device 200 includes an entrance interface converter 210, an L2 frame setting block 220, an integrated layer frame processing block 230, a frame multiplexer 240, an exit interface converter 250, and an integrated layer frame restoration block 260. All of these elements included in the integrated layer frame processing device 200 are connected to the control processor interface 500.

During operation of the integrated layer frame processing device 200, a frame input into the integrated layer frame processing device 200 via the first SPI 410 is processed by the entrance interface converter 210. The entrance interface converter 210 writes information about a physical layer defined in the first SPI 410, for example, the number of physical layer channels and an input channel number, to a physical layer information field 603 (FIG. 5) in the frame, makes a path having a maximum bandwidth regardless of the number of channels of the first SPI 410, and transmits the frame to the L2 frame setting block 220. As well as the physical layer information field 603, other information fields that will be described below are included in an internal frame structure or a variable header used in the integrated layer frame processing device 200. Each field will be described in detail with reference to FIG. 5 later.

The L2 frame setting block 220 receives the frame through the path having the maximum bandwidth, extracts L2 information, e.g., an address of the L2, an ID field, and a protocol, from the frame, and writes the L2 information to an L2 information field 604. Since the type of L2 frame output from the physical layer and MAC layer processor 100 is different according to a line card, the type of L2 protocol like Ethernet or Point-to-Point Protocol (PPP) that the L2 frame setting block 220 supports is predetermined by the control processor interface 500.

The integrated layer frame processing block 230 includes a variable header, which integrates and stores field information of layers such as L2, L3, and L4, and performs different processes according to the layer. In other words, frames respectively including protocols of different layers such as L2, L3, and L4 are divided into different paths according to a field needed by a user. Information about a layer information field required by the integrated layer frame processing block 230 is also predefined by the control processor interface 500.

The frame multiplexer 240 multiplexes frames, which have been processed differently and transmitted through different paths by the integrated layer frame processing block 230 according to the layers, into a single path. The frame multiplexer 240 can change each frame output from the integrated layer frame processing block 230 so as to have a bandwidth of a path desired by a user through the control processor interface 500.

When it is determined that header information is 0 based on channel information in a header information field and a physical layer information field, the exit interface converter 250 removes all information from the variable header, restores an initial frame input to the entrance interface converter 210, and transmits the restored initial frame to the second SPI 420. When it is determined that the header information is not 0, if it is necessary to divide the frame in order to meet the number of channels according to the performance of the network processor 300, the frame is divided based on the number of physical layer channels in a physical layer information field and then output to the second SPI 420. If it is not necessary to divide the frame, the frame is immediately output to the second SPI 420.

If a path flows from the network processor 300 to a physical layer, that is, if a direction in which a frame is output is reversed, the exit interface converter 250 and the entrance interface converter 210 may perform their functions in reverse order.

The integrated layer frame restoration block 260 removes all information of the variable header remaining in a frame that is processed by the network processor 300 and that is output from a router or switch to a corresponding physical layer output port of a line card, and allows the L2 frame setting block 220 to set its L2 address, which is defined through the control processor interface 500, in the frame, and allows the physical layer and MAC layer processor 100 to process a normal standard protocol frame.

FIG. 4 is a detailed diagram illustrating the integrated layer frame processing block 230 included in the integrated layer frame processing device 200 according to the embodiment illustrated in FIG. 3. FIG. 5 is also referred to in the following description.

Referring to FIG. 4, a frame input to the integrated layer frame processing block 230 includes a standard protocol frame with physical layer information. This frame is processed by information processing and filtering sections 231, 232, 233, and 234 according to a protocol predefined through the control processor interface 500 and is sent to a header information processor 235. Since information about what field information is to be inserted into the variable header is shared by the integrated layer frame processing block 230 and the network processor 300 through the control processor interface 500, variable processing of a header is possible.

The L2 information processing and filtering section 231 decides a size of an entire variable header added to the standard protocol frame and writes L2 information to the L2 information field 604. At this time, an L3 information field 605, an L4 information field 606, a hash key field 601, and a header information field 602 are empty. If no other information other than the L2 information is necessary, the header information processor 235 writes the fact that this is the case, i.e., writes a state of each information field to the header information field 602 and outputs the frame through a predetermined path A. If even the L2 information is not necessary and thus all fields including the L2 information field 604 are not necessary in a variable header 610, then this fact is also written to the header information field 602 and the frame is output through the predetermined path A.

Regardless of the existence or non-existence of the L2 information field 604, if other information fields are necessary in an area of the frame that is not updated, the frame is transmitted to the next information processing and filtering section, i.e., the L3 information processing and filtering section 232. The L3 information processing and filtering section 232 extracts information necessary for the L3 information field 605, which is assigned to the L3 information processing and filtering section 232 in advance, from the standard protocol frame and fills the extracted information into the L3 information field 605. If no other information other than the L3 information is necessary, the header information processor 235 records the fact that this is the case into the header information field 602 and outputs the frame to a predetermined path B. If the L3 information and other information that has not yet been extracted are not necessary for the variable header 610, then this fact is also recorded into the header information field 602 and the frame is output through the predetermined path B.

Regardless of the existence or non-existence of the L3 information field 605, if any other information field is necessary in an area of the frame that is not updated, the frame is transmitted to the next information processing and filtering section, i.e., the L4 information processing and filtering section 233. The L4 information processing and filtering section 233 extracts information necessary for the L4 information field 606, which is assigned to the L4 information processing and filtering section 233 in advance, from the standard protocol frame and fills the extracted information into the L4 information field 606. If no other information other than the L4 information is necessary, the header information processor 235 records the fact that this is the case into the header information field 602 and outputs the frame to a predetermined path C. If the L4 information and other information that has not yet been extracted are not necessary for the variable header 610, the fact is also recorded into the header information field 602 and the frame is output through the predetermined path C.

Regardless of the existence or non-existence of the L4 information field 606, if any other information field, e.g., a field for a hash key, that is not updated, is necessary, the frame is transmitted to the next information processing and filtering section, i.e., the hash key generation and output section 234. The hash key generation and output section 234 generates a hash key in the hash key field 601 that is defined to be processed by the network processor 300 and outputs the frame to the header information processor 235. At this time, if at least two fields are defined for the hash key, the hash key generation and output section 234 outputs the frame to the header information processor 235 through at least two paths D and E.

The bandwidth of a frame input to the integrated layer frame processing block 230 is the same as the sum of bandwidths of all frames output from the header information processor 235.

FIG. 5 illustrates the structure of an internal frame used in an embodiment of the present invention. Referring to FIG. 5, the internal frame includes the variable header 610 and a payload field 607. The variable header 610 includes the hash key field 601, the header information field 602, the physical layer information field 603, the L2 information field 604, the L3 information field 605, and the L4 information field 606. However, as described above, the structure of the internal frame may vary according to a user's necessity, that is, a field in the internal frame may be eliminated or expanded.

Meanwhile, the sum of the bits of all the fields in the variable header 610 is less than or equal to a filtering capacity Z of the network processor 300. In other words, the relation A+B+C+D+E+F<=Z is established. Each field has a minimum size of 0 when it does not include corresponding layer information.

Since the range that a line card data processing unit can manage is set in advance so as not to exceed Z bits, the network processor 300 can process a frame in hardware. Accordingly, the network processor 300 can achieve a processing speed higher than several gigabits per second by appropriately controlling the variable header 610 and can also manage QoS or Ipv6 adaptively according to the purpose of the line card data processing unit.

An entire frame structure defined in the standard protocol or a frame structure excluding information extracted to the variable header 610 may be reflected in the payload field 607, in which data is usually stored.

As described above, according to the present invention, a variable header, in which necessary information is compressed and inserted and a hash key is generated, is included in a data field that can be recognized by a network processor, whereby a case where the number of bytes to be processed by the network processor is increased can be managed appropriately. Accordingly, the network processor can support Ipv6 and can map and manage L4 and L2 information as well as L3 information, i.e., Ipv4 in hardware. As a result, when a line card data processing unit of a frame switch and router system uses the present invention, it can secure a bandwidth of more than several gigabits and manage QoS and other services.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An integrated layer frame processing device in a system including a frame switch and a router, the integrated layer frame processing device comprising a variable header into which information is compressed and inserted and in which a hash key is generated in a data field that is recognized by a network processor so as to support a packet processing protocol for the system, the integrated layer frame processing device being disposed between a physical layer and layer 2 processor and the network processor.

2. The integrated layer frame processing device of claim 1, wherein the layer 2 is a media access control (MAC) layer used in Ethernet.

3. The integrated layer frame processing device of claim 1, wherein the physical layer and layer 2 processor and the integrated layer frame processing device are connected through a first system packet interface; the integrated layer frame processing device and the network processor are connected through a second system packet interface; and the physical layer and layer 2 processor, the integrated layer frame processing device, and the network processor are connected to a control processor interface that defines setting information of each layer in open system interconnection for a user, a type of frame to be processed, and a size of each layer information field.

4. The integrated layer frame processing device of claim 3, further comprising:
an entrance interface converter storing information about a physical layer defined in the first system packet interface in a physical layer information field in the variable header of the data field, transmitting a frame through a path having a maximum bandwidth regardless of the number of channels of the first system packet interface, and writing channel information into a physical layer information field in the variable header;
a layer 2 frame setting block receiving the frame through the path having the maximum bandwidth, extracting layer 2 information from a frame predefined in a layer 2 protocol, and storing the layer 2 information in a layer 2 information field in the data field;
an integrated layer frame processing block comprising the variable header which integrates and stores different layer information predefined by the control processor interface and performing processes according to a layer;
a frame multiplexer multiplexing frames differently processed by the integrated layer frame processing block into a single path and varying a bandwidth of the path through the control processor interface;
an exit interface converter receiving header information from a header information field in the data field and the channel information from the physical layer information field, removing all content of the variable header from the data field when the header information is 0, restoring an initial frame input to the entrance interface converter, outputting the initial frame to the second system packet interface, and outputting the content of the variable header to the second system packet interface when the header information is not 0; and
an integrated layer frame restoration block removing the content of the variable header from a frame that is processed by the network processor and output to a corresponding physical layer port, allowing the layer 2 frame setting block to set. in the frame its layer 2 address defined by the control processor interface and allowing the physical layer and layer 2 processor to process a normal standard protocol frame.

5. The integrated layer frame processing device of claim 4, wherein the physical layer information comprises the number of channels in the physical layer and an input channel number, and the layer 2 information comprises an address of a layer 2, an ID field, and a protocol.

6. The integrated layer frame processing device of claim 4, wherein the data field comprises the variable header and a payload field.

7. The integrated layer frame processing device of claim 6, wherein the payload field reflects an entire frame structure defined in a standard protocol or a frame excluding information extracted to the variable header.

8. The integrated layer frame processing device of claim 6, wherein the variable header varies so as to support a packet processing protocol for the system.

9. The integrated layer frame processing device of claim 6, wherein the variable header comprises a hash key field, the header information field, the physical layer information field, the layer 2 information field, a layer 3 information field, and a layer 4 information field.

10. The integrated layer frame processing device of claim 4, wherein, when a direction in which a frame is output is reversed, the exit interface converter and the entrance interface converter perform their functions in reverse order.

11. The integrated layer frame processing device of claim 4, wherein, when the header information is not 0, the frame is divided based on the number of channels in the physical layer defined in the physical layer information according to performance of the network processor and is then output to the second system packet interface.

12. The integrated layer frame processing device of claim 4, wherein the integrated layer frame processing block comprises:
an information processor receiving information and a size needed to construct a frame in the data field through the control processor interface, extracting information about each layer, and inserting the information into a corresponding layer information field in the variable header; and
a hash key generation and output section generating a hash key and writing the hash key into a hash key field in the variable header.

13. The integrated layer frame processing device of claim 12, wherein the information processor comprises a layer information processing and filtering section for each layer, and the integrated layer frame processing block further comprises a header information processor receiving outputs from the information processor and the hash key generation and output section and inserting corresponding layer information into the header information field in the variable header.

14. The integrated layer frame processing device of claim 13, wherein a bandwidth of a frame input to the integrated layer frame processing block is the same as a sum of bandwidths of all frames output from the header information processor, and the variable header has a minimum size of 0 and a maximum size corresponding to a sum of bits in every field in the variable header, which is less than or equal to a filtering capacity of the network processor.
